(19) United States
(12) Patent Application Publication
(10) Pub. No.: US 2017/0287189 A1
(43) Pub. Date: Oct. 5, 2017

(54) DISPLAYING A DOCUMENT AS MIXED REALITY CONTENT

(71) Applicant: CANON KABUSHIKI KAISHA, Tokyo (JP)

(72) Inventor: Berty Jacques Alain Bhuruth, Bankstown (AU)

(21) Appl. No.: 15/472,023

(22) Filed: Mar. 28, 2017

(30) Foreign Application Priority Data
Mar. 30, 2016 (AU) 2016201974

(51) Int. Cl. G06T 11/60; G06F 3/01; G06Q 10/10; G06F 3/00

(52) U.S. Cl. CPC G06T 11/60; G06F 3/005; G06F 3/017; G06F 3/011; G06Q 10/10

(57) ABSTRACT

A computer-implementable system and method of displaying a document as mixed reality content. The method comprises determining, via an image of a physical environment, a relationship between an orientation of a physical document, a presenter of the physical document, and a viewer of the physical document in the physical environment; and retrieving a virtual representation of the physical document when the determined relationship indicates that the physical document is presented to the viewer. The method further comprises displaying the retrieved virtual representation of the document to the viewer as mixed reality content in the physical environment.

### REFERENCE TO RELATED PATENT APPLICATION(S)

This application claims the benefit under 35 U.S.C. §119 of the filing date of Australian Patent Application No. 2016201974, filed 30 Mar. 2016, hereby incorporated by reference in its entirety as if fully set forth herein.

### TECHNICAL FIELD

This invention relates to a method and system for display of a non-physical representation of a document as mixed reality content. The invention also relates to control of display of the non-physical representation of the document.

### BACKGROUND

Mixed reality relates to merging of a surrounding physical environment viewed by a user with digital content, referred to as mixed reality content, such that the digital (non-physical) content and the surrounding environment may be seen as interactive from a point of view of a user. In a mixed reality environment, a user is typically able to at least partially view the surrounding environment in addition to mixed reality content, for example by projection of the mixed reality content onto the surrounding environment, such as a desk. A smart office provides one example of an implementation of a mixed reality environment.

The concept of a smart office is appealing to businesses and workers as smart offices are promoted as capable of increasing efficiency. An ideal smart office environment is described as a smart space where a smart office system can sense contextual elements of the environment and drive physical and non-physical functions which benefit the users in the environment. The ideal smart office system will also allow users the capability to freely access and interact with content regardless of whether the content is physical or non-physical. Additionally, technology of smart offices allows non-physical content to be interacted with and manipulated in just the same way as physical content. Technology progresses towards the ideal description of a smart office environment but still with limitations that undesirably affect the user's experience. The easy and intuitive sharing of information is an area of smart office systems that experiences limitations affecting user experience.

An important aspect of sharing in a smart office environment is being able to know what information to share between users and how to share the information. One known technique detects characteristics of a group and decides which content to display. By detecting the number of people in an environment and their attention, age, race, gender and the turnover rate of the group, such systems determine which advert from a database of adverts to play. In the perspective of context awareness for a meeting such solutions are incomplete solutions as complete control is given to the smart office system to determine which content is displayed. Further, information is shown for the group regardless of wishes of an individual person.

In a meeting use case, a scenario could exist where one person has a physical copy of the document while one or more individuals do not. The person with the document is required to electronically share the document with the others. When a user intends to share a document the user needs to manually instruct the smart office system via an explicit command to share. Similarly a user needs to manually instruct the system when they intend to recover the shared document.

One existing arrangement explores ways to control how an electronic document on a table-top display can be shared. The existing arrangement relates to the user performing a reorientation gesture with the electronic document. When the document is facing the owner then only the owner can move or modify the document. When the electronic document is facing away from the owner, other users are granted access to move or modify the document. The method is used to control the sharing of a single electronic document. The method also creates a scenario where when the user reorientates the documents away from them, such negatively affects the ability of the user to use the document.

Another known technique that uses object rotation to control display of information relates to the display of information during 360 degree product spins, as commonly found on online stores. As the user controls the rotational view of the onscreen product, different information is accessible to the user. The effect of rotational display is usually defined by a developer of the display control system at the time of authoring—given a correct orientation, additional information is displayed about the product. The limitation of the product spin technique is the content generated via an orientation is predefined and unchanging. Integrated as part of the smart office meeting use case, use of such a technique could not modify display of information based on different contexts that could arise.

As shown, there are clear shortcomings in relation to sharing information in a smart office environment.

### SUMMARY

It is an object of the present disclosure to substantially overcome, or at least ameliorate, at least one disadvantage of present arrangements.

A first aspect of the present disclosure provides a computer-implementable method of displaying a document as mixed reality content, the method comprising: determining, via an image of a physical environment, a relationship between an orientation of a physical document, a presenter of the physical document, and a viewer of the physical document in the physical environment; retrieving a virtual representation of the physical document when the determined relationship indicates that the physical document is presented to the viewer; and displaying the retrieved virtual representation of the document to the viewer as mixed reality content in the physical environment.

According to another aspect, the method further comprises determining that the presenter is viewing the physical document from the determined relationship; and providing the viewer of the document with control of display of the virtual representation of the document.

According to another aspect, the method further comprises determining that the presenter is not viewing the physical document according to the determined relationship; and providing the presenter of the document with control of display of the virtual representation of the document.

According to another aspect, the method further comprises: detecting, via the image, a number of people in the environment, determining a count of how many of the people are viewing the physical document; and displaying the retrieved virtual representation to each of the people viewing the physical document, each displayed representation associated with a display duration determined according to the count of how many people are viewing the physical document.

According to another aspect, the display duration is determined according to a duration of the presentation of the physical document.

According to another aspect, the viewer of the virtual document is provided control of the display of the virtual representation of the document if the viewer interacts with the virtual document.

According to another aspect, the method further comprises: detecting, via the image, a number of people in the environment, determining a count of how many of the people are viewing the physical document in the environment; determining which of the people viewing the physical document lack a physical copy of the document; and displaying the retrieved virtual representation as mixed reality content to each of the people determined to lack a physical document.

According to another aspect, the method further comprises: detecting a number of people in the environment, and determining whether the people are within a viewing space associated with the physical document, wherein the representation of the retrieved virtual copy is displayed to each person determine to be within the viewing space.

According to another aspect, the method further comprises determining, via the image, a viewing space of the physical document, and determining, via one or more subsequent images, viewers of the document based upon detecting entry of one or more people into the viewing space within a predetermined time.

According to another aspect, determining the relationship between the orientation of a physical document, the presenter of the physical document, and the viewer of the physical document in the physical environment comprises: detecting that the presenter is presenting the document; and detecting an interaction of the viewer in relation to the physical document.

According to another aspect, the virtual representation of the document is displayed as mixed reality content by projection of the virtual representation in the physical environment.

Another aspect of the present disclosure provides a computer-implementable method of displaying a document as mixed reality content, the method comprising: detecting, via an image of a physical environment, that a physical document is presented to an audience in the physical environment; determining, via the image, a count of how many people are in the audience, retrieving a virtual representation of the physical document when the physical document is presented to the audience in the physical environment; and displaying, as mixed reality content in the physical environment, the retrieved virtual representation to each of the audience, each displayed representation having a display duration determined according to the count of people in the audience and a duration of the presentation of the physical document.

According to another aspect, the display duration is determined according to whether a person presenting the physical document to the audience is viewing the physical document.

According to another aspect, display of each virtual representation of the document is terminated after the display duration has ended.

According to another aspect, one or more display characteristics of each virtual representation of the document is modified after the display duration has ended.

Another aspect of the present disclosure provides a mixed reality system, configured to: capture an image of a physical environment; determine, via the image, a relationship between an orientation of a physical document, a presenter of the physical document, and a viewer of the physical document in the physical environment; retrieve a virtual representation of the physical document when the determined relationship indicates that the physical document is presented to the viewer; and display the retrieved virtual representation of the document to the viewer as mixed reality content in the physical environment.

Another aspect of the present disclosure provides an apparatus, comprising: a processor an image capture device for capturing an image of a physical environment; and a memory, the memory having instructions thereon executable by the processor to: determine, via the image of a physical environment, a relationship between an orientation of a physical document, a presenter of the physical document, and a viewer of the physical document in the physical environment; retrieve a virtual representation of the physical document when the determined relationship indicates that the physical document is presented to the viewer; and display the retrieved virtual representation of the document to the viewer as mixed reality content in the physical environment.

Another aspect of the present disclosure provides a non-transitory computer readable storage medium having a computer program stored thereon for modifying display of augmented reality content, comprising: code for detecting, via an image of a physical environment, that a physical document is presented to an audience in the physical environment; code for determining, via the image, a count of how many people are in the audience; code for retrieving a virtual representation of the physical document when the physical document is presented to the audience in the physical environment; and code for displaying, as mixed reality content in the physical environment, the retrieved virtual representation to each of the audience, each displayed representation having a display duration determined according to the count of people in the audience and a duration of the presentation of the physical document.

### BRIEF DESCRIPTION OF THE DRAWINGS

One or more embodiments of the invention will now be described with reference to the following drawings, in which:

FIG. 1A depicts one possible hardware arrangement of a system for displaying a document as mixed reality content;

FIGS. 1B and 1C form a schematic block diagram of a general purpose computer system upon which arrangements described can be practiced:

FIG. 2 is a schematic flow diagram illustrating an example computer-implementable method of displaying a document as mixed reality content;

FIG. 3 is a schematic flow diagram illustrating a method of confirming a person is presenting a document as implemented in FIG. 2;

FIG. 4 is a schematic flow diagram illustrating a method of defining control parameters for a non-physical representation of a document, as used in FIG. 2;

FIG. 5 is a schematic flow diagram illustrating a method of managing the control parameters for display of a non-physical representation of a document;

FIGS. 6A and 6B show an example of displaying a document as mixed reality content;

FIGS. 7A to 7D show another example of displaying a document as mixed reality content; and

FIG. 8 shows a further example computer-implementable method of displaying a document as mixed reality content.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

The methods disclosed herein use mixed reality content, where the mixed reality content can be either projected using a projector or displayed through augmented reality glasses (also referred to as a head mountable display). The arrangements described are advantageous in multi user collaborative environments. The arrangements described are related to context awareness, as the method of display of a document and control changes is based on detecting contextual elements from the environment.

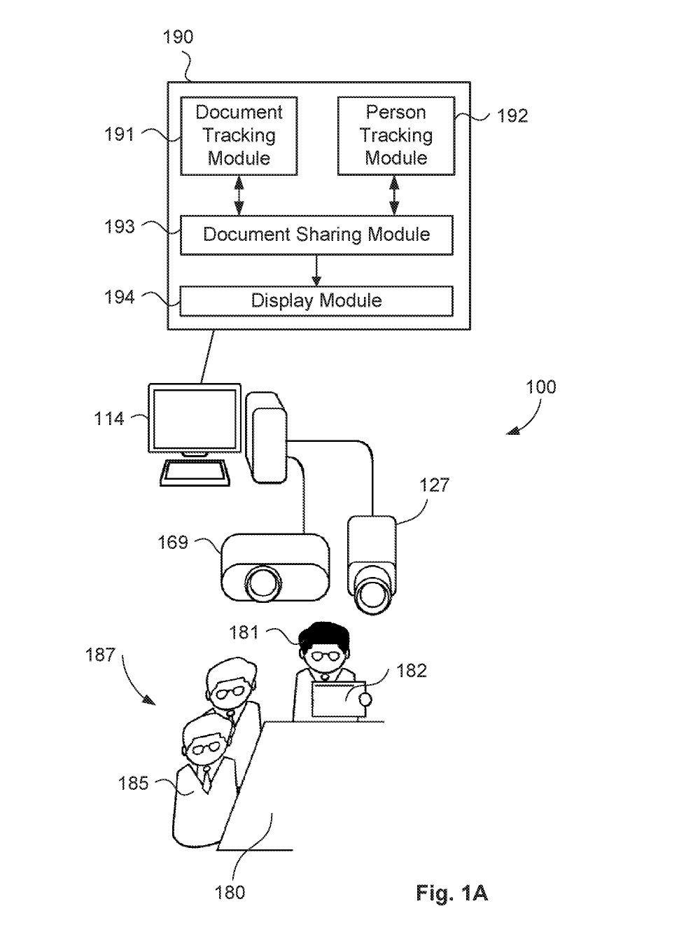

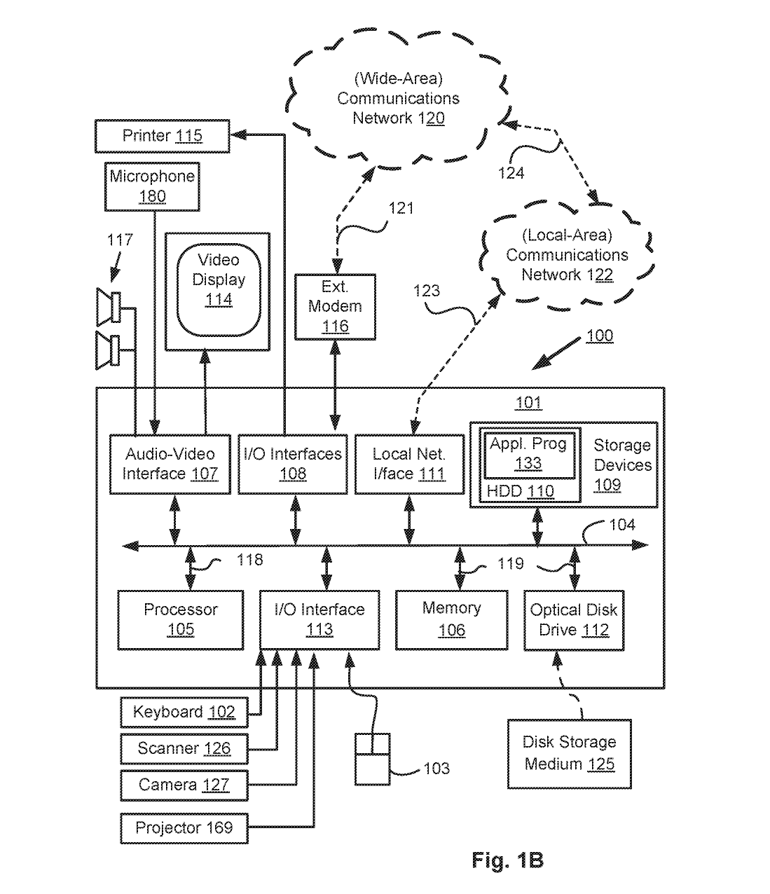

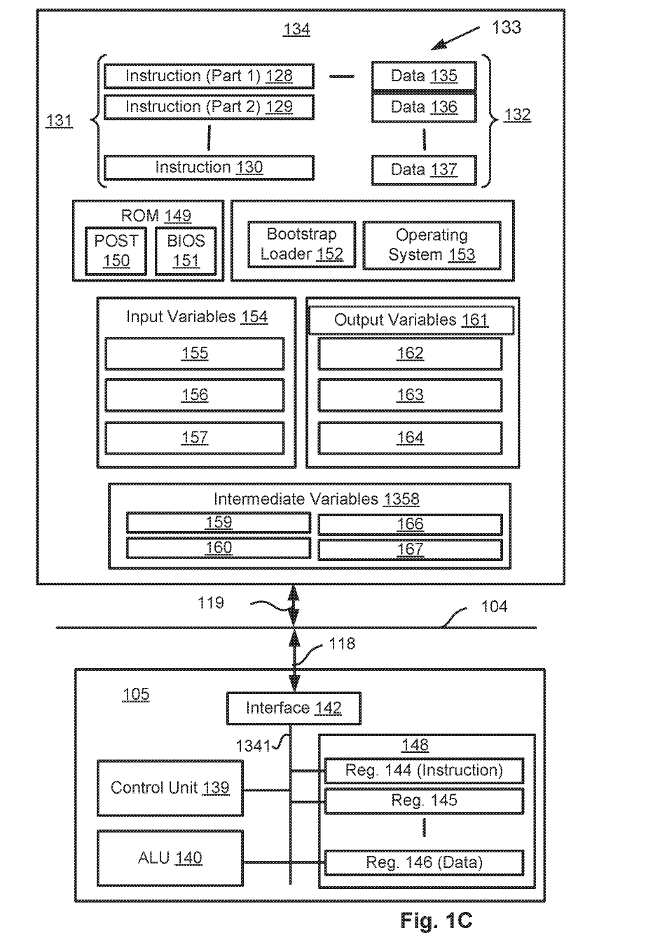

A system for intelligently displaying and managing a shared non-physical document is described below in relation to FIGS. 1A to 1C.

FIG. 1A shows an outline hardware configuration of a system 100 according to one arrangement. The system 100 comprises a computer module 101. The computer module 101 contains a central processing unit, memory and input and outputs, as described hereafter in relation to FIGS. 1B and 1C. The computer module 101 processes footage or images captured by a camera 127. The camera 127 may be any image capture device suitable for capturing images or video. The camera 127 outputs a stream of image frames, the frames capturing images of a physical environment 187, for example an office or meeting room. The arrangements disclosed are performed by the central processing unit executing instructions indicated by a software architecture 190. Following processing of the received footage, content is transmitted from the computer module 101 to a projector 169 to be displayed to one or more users. A document owner 181 and a pair of people 185 provide example of users of the system 100. In the arrangements described the document owner 181 is a presenter of a document 182, and the people 185 are viewers or an audience of the document 182. The people 181 and 185 are in the environment 187. The projected content is displayed on a display surface 180 in the environment 187 for the users 185 to view or experience.

The example of FIG. 1A relates to only one configuration for which the arrangements described can be implemented. Depending on the configuration of the environment 187, the system 100 may have multiple projectors and cameras to provide a richer experience to the users. In a further configuration, the projector 169 and the camera 127 are replaced with a number of head mountable displays, each worn by the viewers 184 and the presenter 181 comprising both a camera and a lens display to display content. The head mountable displays would typically connect wirelessly to the computer module 101.

The arrangements described relate to a method of automatically generating non-physical representations of a document (also referred to as non-physical copies, virtual representations or virtual copies) upon detecting intent from a presenter to share a physical document. The arrangements described further assigning control over display of the non-physical copies to either the presenter or the viewer(s), based on how the document is shared. The arrangements described first determine intent by determining orientation of the physical document in relationship to the presenter and viewers. Based on the determined relationship the arrangements described define initial control parameters for displaying the non-physical representation prior to displaying the non-physical representation so that the control parameters match the manner in which the presenter is sharing the physical document.

Depending on the initial control parameter, the presenter may or may not have control over recovery of the shared non-physical document representations. If control is assigned to the presenter, the display of the representations is dependent on the persisted sharing of the physical document. In such an event, the representations are displayed as long as the presenter is sharing the document. The viewer does have the opportunity to attain control of the display of the representation by interacting with the display of the representation, thereby demonstrating a higher level of engagement than a passive viewer. If initial control is assigned to the viewer then the representations are displayed without any relationship to the presenter.

In a first arrangement, the presenter 181 shares the physical document 182 with the group of viewers 185 by showing or presenting the document 182 to the viewers 185. The presenter 181 is standing at the head of the table 180 similarly to giving a presentation in a meeting.

FIG. 1A also shows the software architecture 190. Images captured by the camera 127 are passed to a document tracking module 191 and a person tracking module 192. The document tracking module 191 uses computer vision methods to identify physical documents and track spatial orientation of the physical documents in the environment. Examples of computer vision methods to identify physical documents include recognising a unique marker printed on the physical document such as a two dimensional bar code or a QR code, or recognising the features of the document. Features of the document may be processed to form feature vectors using techniques such as Scale Invariant Feature Transform for natural images such as photos and Brick Wall Coding for images of text.

The document tracking module 191 also has the ability to recognise the difference between a physical and non-physical document, for example by detecting the contrast of a physical document verses a non-physical document. However, the document tracking module 191 will know the location of the non-physical documents generated by the software architecture 190 and projected by the projector 169. Since the location of the non-physical documents are known a foreground segmentation technique may be used to remove the non-physical document and replace the non-physical document with an image of the surface previously captured, and stored in memory. The person tracking module 192 uses computer vision methods to identify people within the environment. Examples of computer vision methods to identify people include Face detection, skeletal detection, detecting shape, colour & clothing as well as infrared. Included in the person tracking module 192 is an ability to perform gaze tracking and gesture recognition.

The document tracking module 191 and the person tracking module 192 send information to the document sharing module 163. The document sharing module 193 performs a task of determining which of the identified people is the presenter 181 and which of the identified people are the viewers or audience. The document sharing module 193 also determines the required number of non-physical document representations to display. The document sharing module 193 also defines and manages the control parameters for each displayed non-physical representation based on information received from the document tracking module 191 and person tracking module 192. The software architecture 190 also includes a display module 194. The display module 194 controls display of virtual representations of the document as mixed reality content, for example via the projector 169.

FIGS. 1B and 1C depict the general-purpose computer system 100, upon which the various arrangements described can be practiced.

As seen in FIG. 1B, the computer system 100 includes: the computer module 101; input devices such as a keyboard 102, a mouse pointer device 103, a scanner 126, the camera 127, and a microphone 180; and output devices including a printer 115, the display device 114, the projector 169 and loudspeakers 117.

The camera 127 and the projector 169 may in some arrangements be separate devices in communication with the computer module 101. The camera 127 and the projector 169 may each communicate with the computer module 101 via wired or wireless communication, or a combination or wired and wireless communication. Alternatively, the camera 127 and/or the projector 169 may be integral to the computer module 101. In other arrangements, as discussed above, the camera 127 and projector 169 may be replaced by a number of head mountable displays in communication with the computer module 101.

An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105 (also referred to as a central processing unit), and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127, projector 169 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1B, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PCs and compatibles, Sun Sparcstations, Apple Mac™ or like computer systems.

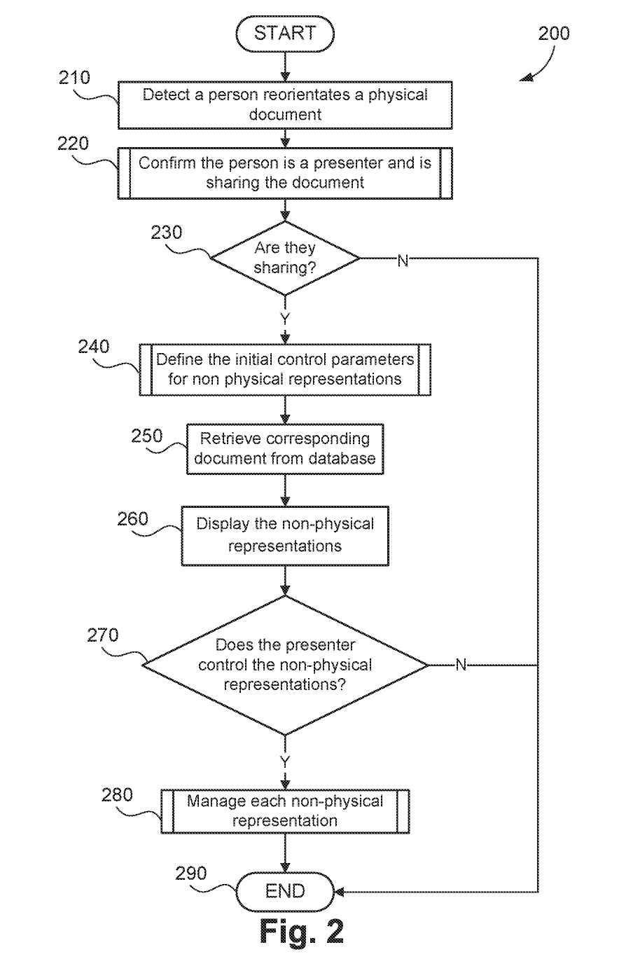

The method of displaying a document may be implemented using the computer system 100 wherein the processes of FIGS. 2-5 and 8 to be described, may be implemented as one or more software application programs executable within the computer system 100. In particular, the steps of the methods of FIGS. 2-5 and 8 are effected by instructions 131 (see FIG. 1C) in the software 133 that are carried out within the computer system 100. For example, the software architecture 190 is typically implemented as one or more modules of the software application 133. The software instructions 131 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software 133 is typically stored in the HDD 110 or the memory 106. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for the methods of displaying a document as mixed reality content described hereafter.

Thus, for example, the software 133 may be stored on an optically readable disk storage medium (e.g., CD-ROM) 125 that is read by the optical disk drive 112. A computer readable medium having such software or computer program recorded on it is a computer program product. In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD. Blu-Ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1C is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1B.

When the computer module 101 is initially powered up, a power-on self-test (POST) program 150 executes. The POST program 150 is typically stored in a ROM 149 of the semiconductor memory 106 of FIG. 1B. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1B. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1B must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1C, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1B. The execution of a set of the instructions may in some cases result in output of data Execution may also involve storing data or variables to the memory 134.

The described arrangements use input variables 154, which are stored in the memory 134 in corresponding memory locations 155, 156, 157. The described arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1C, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:

a fetch operation, which fetches or reads an instruction 131 from a memory location 128, 129, 130:

a decode operation in which the control unit 139 determines which instruction has been fetched; and

an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 2-5 and 8 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The methods described may alternatively be implemented in dedicated hardware such as one or more integrated circuits performing the functions or sub functions of the methods described hereafter. Such dedicated hardware may include graphic processors, digital signal processors, or one or more microprocessors and associated memories.

FIG. 2 shows a schematic flow diagram of a computer-implementable method 200 of displaying a document as mixed reality content. The method 200 shows how the system 100 manages the sharing of a non-physical representation of a physical document such as the document 182. The method 200 is typically implemented as one or more modules of the application 133, controlled by execution of the processor 105, and stored in the memory 106.

The method 200 starts at a detection step 210. The step 210 involves the application 133 detecting a change in orientation of the physical document 182, caused by a person in the environment 187. As described above detecting the change in orientation of the physical document is done by receiving an image of the physical environment 187 from the camera 127 at the document tracking module 191 and at the person tracking module 192.

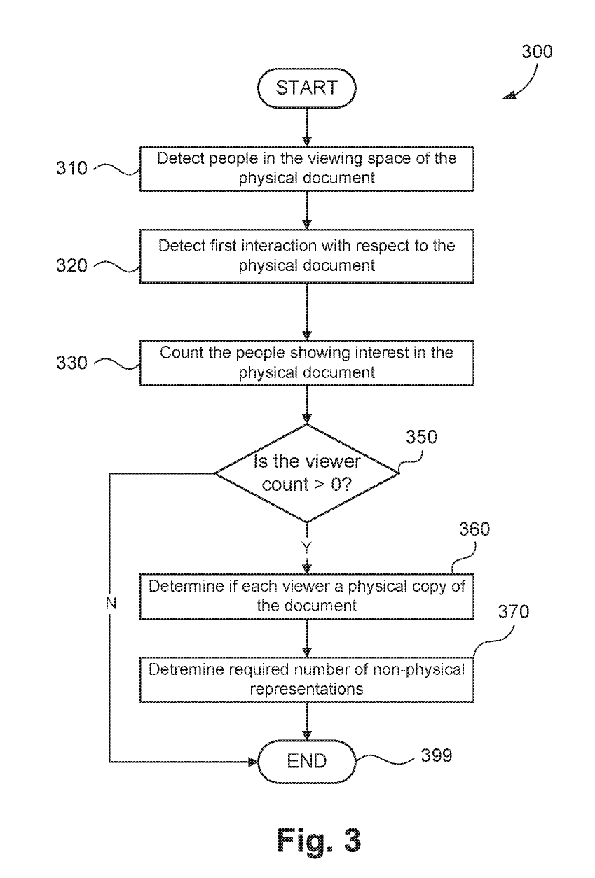

The method 200 continues under execution of the processor 105 to a confirming step 220. The application 133 determines if the person (for example the person 181) who reorientated the document is a presenter and is sharing the physical document 182 with others at the step 220. A method 300 of confirming a person is a presenter, as implemented at the step 220, is described hereafter in relation to FIG. 3. Outputs from the step 220 include a count of viewers of the physical document and a copy count indicating the number of representations to be displayed, as described in relation to FIG. 3. The viewer count includes an indication of whether the presenter is also a viewer of the document.

The method 200 progresses under execution of the processor 105 to a check step 230. Based on the determination at step 220, the application 133 decides if the person is sharing the document or not at the check step 230 using the viewer count and, in some arrangements, the copy count. If the person is found not to be sharing the document (“N” at the step 230), the method 200 continues to a step 290 and ends. The person may be found not to be sharing if the viewer count, or the copy count, is zero for example.

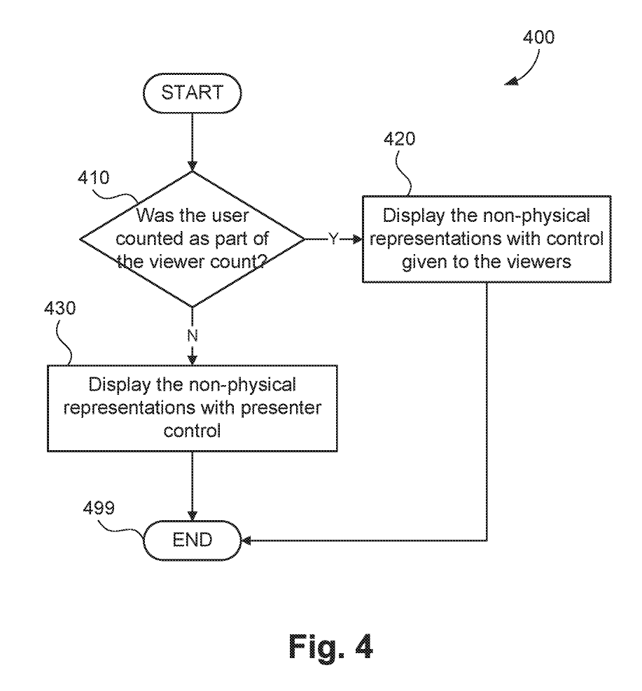

If the person is determined to be a presenter sharing the physical document (“Y” at step 230), the method 200 progresses under execution of the processor 105 to a definition step 240. In execution of the step 240, the application 240 defines sharing parameters for virtual (non-physical) representation of the document. A method 400 of defining initial control parameters, as executed at step 240, is described hereafter in relation to FIG. 4.

The method 200 continues under execution of the processor from the definition step 240 to a retrieval step 250. In execution of the step 250, the application 133 retrieves a virtual or electronic version of the document relating to the physical document being shared from a central database. The database may be stored on the module 101, for example in the memory 106, or on a remote device in communication with the module 101.

Retrieving the corresponding virtual version of the document may be implemented in a number of ways. For example, a machine-readable identifier such as a watermark or a QR code may form a part of the document. In such implementations, the application 133 executes to read the identifier and retrieve a corresponding identified document. In other arrangements, the application 133 may perform image analysis of the physical document, for example generating feature vectors, and compare the feature vectors to documents stored in the database. The database of documents may be limited to documents associated with a meeting (predefined by the users) or may relate to a general database of documents associated with an organisation. In a yet further arrangement, the virtual document may be generated from the image captured by the camera 127.

The method 200 progresses from the retrieval step 250 to a display step 260. Based on the copy count determined at step 220, the application 133 executes to display non-physical representations of the document as mixed reality content in the environment 187 to each of the viewers 185, for example projecting the representations in the environment using the projector 169. In some arrangements, representations of the document are only provided to those of the audience 185 who do not have a physical copy of the document.

The computer module 101 typically introduces the non-physical copies to the viewers 185 using an animation that gives a visual illusion that the virtual representations emanate from the physical document. The illusion is achieved by the projector first projecting the non-physical representation over the physical document and then gradually moving the non-physical representation to the intended position in front of the viewer.

The method 200 continues under execution of the processor 105 to a check step 270. At the step 270, the method 200 determines if the presenter 181 controls display of the non-physical copies of the document. If the presenter does not have control over the non-physical representations (“N” at step 270), the method 200 ends by progressing to the step 290. Such allows the non-physical document representations to remain displayed regardless of the actions of the presenter.

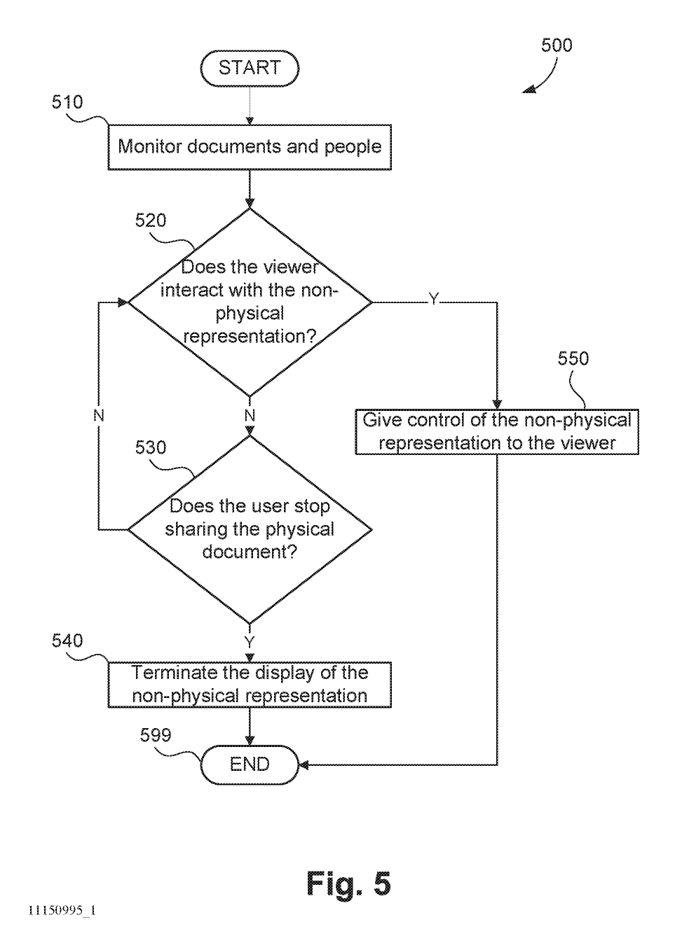

If the presenter does have control of display of the non-physical representation (“Y” at step 270), the method 200 continues to a management step 280. In execution of the management step 280 the application 133 manages each non-physical representation separately. Two outcomes are possible from step 280. Firstly, each non-physical representation remains displayed for the duration of time the presenter is presenting the physical document. Alternatively, a viewer interacts with their corresponding non-physical representation and is afforded control over the corresponding non-physical representation. A method 500 of managing each non-physical representation, as executed at the step 280, is described in detail in relation to FIG. 5. Regardless of the outcome of step 280, the method 200 will proceed to end at the step 290.

FIG. 3 shows the schematic flow diagram of the method 300. FIG. 3 shows how the system 100 determines if a person who reorientates a physical document is a presenter and intends to share the document. The method 300 is typically implemented as one or more modules of the application 133, controlled by execution of the processor 105, and stored in the memory 106.

The method 300 begins at a detecting step 310. In execution of the detecting step 310, the application 133 executes to detect the spatial position of the physical document and whether there are people in the physical environment. In particular, the step 310 determines whether the people are within a viewing space of the physical document 310.

In the arrangements described, the viewing space of the document relates to a 3 dimensional space or environment around the physical document in which the content of the document is still legible to an average person. Detection of the document and people within the viewing space may be implemented using known image recognition techniques to process images or sequences received from the camera 127.

After detecting presence of people (such as the group 185 and the presenter 181), the method 300 continues to a detecting step 320. In execution of the step 320, the application 133 looks for a first interaction by the detected people indicating their interest in the physical document (such as the document 182). Detecting a first interaction can be achieved in multiple ways. One type of first interaction detected by the system 100 is a gaze interaction. Detecting a gaze interaction is achieved by tracking an eye of a person using standard techniques such as Eye tracking in the Wild by Hansen et al (Hansen, D. W.; Pece, A. E. C.; Eye tracking in the wild; Computer Vision and Image Understanding 2005, 98, pp 155-181). If a gaze of a person is registered to shift towards the physical document 182, the application 133 operates to detect that the person is interested in the document 182. A second type of first interaction detected by the system is a gesture interaction. Detecting a gesture interaction is achieved by recognising a gesture made by a person using standard techniques such as, face and body gesture recognition for a vision-based multimodal analyser by Gunes et al (Hatice Gunes, Massimo Piccardi, Tony Jan. Face and body gesture recognition for a vision-based multimodal analyser; In Conferences in Research and Practice in Information Technology, Proceedings from The Pan—Sydney Area Workshop on Visual Information Processing (VIP2003), Sydney, June 2004; Massimo Piccardi, Tom Hintz, Sean He, Mao Lin Huang, David Dagen Feng, Ed. Australian Computer Society, Inc.; Darlinghurst, Australia, Australia ©2004, June 2004; p 19-28). If there is any movement, body behaviour or facial gesture performed by a person in respect to the physical document e.g. rotating their body towards the document, then the application 133 operates to detect that the person is interested in the physical document.

The method 300 continues to a count step 330. In execution of the count step 330 the application 133 executes to count the number of people detected to have indicated interest in the document at step 320. The application 133 stores the number of viewers in memory, such as the memory 106. The application 133 also records information of whether the presenter is a viewer of the physical document.

In determining the people viewing the document, the steps 310 to 330 effectively operate to determine, via the image of the physical environment captured by the camera 127, a relationship between the physical document, the presenter of the physical document, and the viewers of the physical document. A relationship of the viewer with the physical document is determined by detecting an interaction of the viewer in relation to the physical document

The application 133 continues under execution of the processor 105 to a check step 350. In execution of the step 350, the application 133 determines if the viewer count of step 330 is greater than zero. If the view count is greater than zero (“Y” at step 350), the person with the physical document (presenter, e.g. the person 181) is sharing with at least 1 viewer and the method 300 continues to a determining step 360, described hereafter.

If the viewer count is determined to be zero (“N” at step 350), that is the application 133 determines that there was no intention to share and that the detected reorientation of the document (step 210) was simply the user moving some documents around. Determining a viewer count of zero causes the method 300 to end at step 399. Referring back to FIG. 2, a viewer count of zero results in determining at step 230 that the person 181 is not sharing the physical document 182.

In execution of the step 360 the application 133 looks in the vicinity of each counted viewer to determine if the viewer has a physical copy of the document 182 already. Determining whether the viewer has a physical copy may be implemented using techniques similar to those for retrieving the virtual version of the document, such as detecting a machine-readable identifier, or performing a comparison with the physical document. The number of viewers determined to have a physical copy of the document is stored in the memory 106.

The method 133 progresses to a determining step 370. The application 133 determines the required number of non-physical representations in execution of the step 370. Determining the required number of non-physical representations is calculated by subtracting the number of viewers who are detected to have physical copies from the total viewer count determined at the step 330. The number of representations required is stored in the memory 106. Following step 370 the method 300 ends at the step 399. In ending at the step 399, the method 300 outputs information to step 230 of FIG. 2 indicating whether a presenter is sharing a document, and with how many people.

FIG. 4 shows the method 400 of defining the initial control parameters for display of the non-physical representations, as executed at step 240 of FIG. 2. The method 400 is typically implemented as one or more modules of the application 133, controlled by execution of the processor 105, and stored in the memory 106. The control parameters relate to a display duration of each virtual representation of the document.

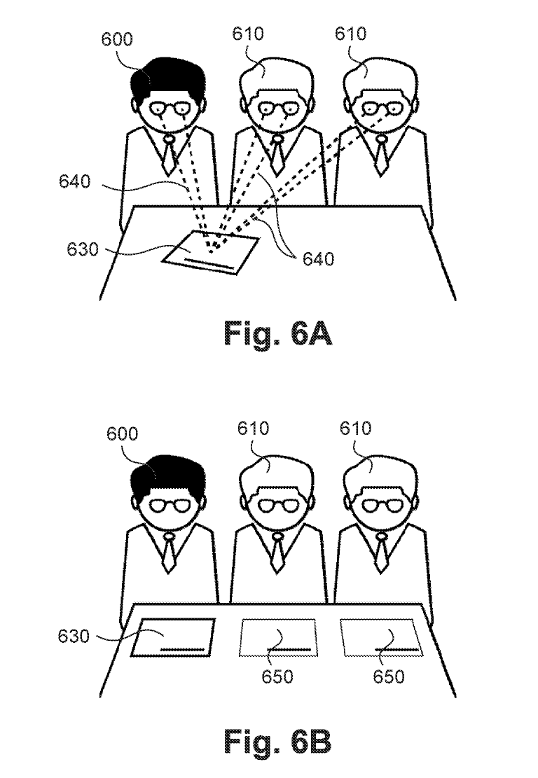

The method 400 starts at step 410. Step 410 is executed by determining if the presenter was counted in the viewer count, i.e. that the presenter is viewing the physical document. The presenter is counted in the viewer count if the document is angled so that the presenter and viewers can all see the document. If the document is held up so that only the viewers can see the document, allowing the presenter to only see the back of the document, then the presenter is not counted in the view count. If the presenter is in the viewer count and is thus also a viewer of the physical document 182 (“Y” at step 410), the method 400 continues to a step 420. Execution of the step 420 sets control parameters of the non-physical representations are displayed without the presenter having control over display of the non-physical representations. Accordingly, the display duration of the representations depends on the number of viewers of the document. The setting of control parameters at step 420 is described in relation to FIGS. 6A and 6B hereafter.

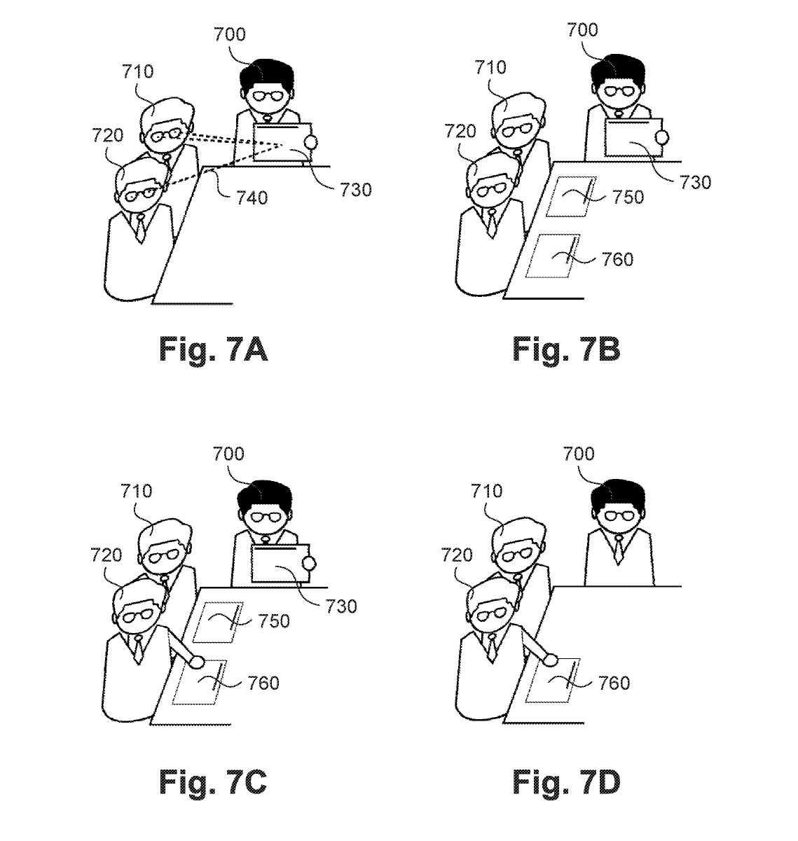

If the presenter is not a viewer of the physical document the method 400 continues to a step 430. Execution of the step 430 defines control parameters such that the non-physical document representations are displayed with the presenter having control over their display. The duration of display of the representation in such an instance depends upon a duration of the presentation of the physical document—if the presenter stops sharing the document, the representations are no longer displayed. The setting of control parameters is described in relation to FIGS. 7A-D. After execution of either step 420 or step 430, the method 400 ends at a step 499.

FIG. 5 shows method 500 of managing display of each non-physical document copy. The method 500 is typically implemented as one or more modules of the application 133, controlled by execution of the processor 105, and stored in the memory 106.

The method 500 starts at a monitoring step 510. The step 510 executes to monitor both documents and people in the environment 187. Documents that are monitored at step 510 include both the physical document 182 and the non-physical representations of the document 182 displayed to viewers. The people that are monitored at step 510 include the presenter and the viewers. The step 510 is performed by processing input frames from the camera 127 by the document tracking module 191 and the person tracking module 192. The method 500 performs a step 520 for every frame received from the camera 127.

The step 520 executes to detect if a viewer is interacting with a non-physical representation with which the viewer is associated. Interaction by the viewer typically relates to identification of a predefined gesture by the application 133, for example a swipe gesture, a user placing a hand on a particular portion of the representation, a pinch gesture and the like. An example of an interaction by a viewer could be to interact with some interactive content on the page, change page of the document copy, change the display scale of the page content, etc. using appropriate gestures. If the viewer is detected to have interacted with their corresponding non-physical representation then the method 500 continues to a step 550. At step 550 the application 133 assigns or provides control of display the non-physical representation to the viewer. After executing step 550, the method 500 ends at a step 599. The reasoning for giving control to the viewer at step 550 is described hereafter in relation to FIGS. 7a-d.

If the viewer has not interacted with the copy (“N” at step 520), the method 500 continues to a step 530. The step 530 is executed for the same input frame as the step 520. The application 133 determines the status of the presented physical document at step 530. The application 133 decides if the presenter is still sharing the physical document at step 530. The determination whether the user is sharing the document could be made in more than one way. The arrangements described detect another orientation change of the physical document resulting in an orientation where the viewers are no longer within the viewing space of the physical document. If the physical document remains in a presented state (“N” at step 530), then the method 500 returns to step 520 to process a new input frame from the camera 127.

If the presenter has stopped sharing the physical document (“Y” at step 530), then the method 500 continues to step 540. In step 540 the application 133 terminates display of the non-physical representation. On execution of the step 540 the method 500 ends at step 599.

FIGS. 6a and 6b show graphical illustrations of example scenarios of displaying a document as mixed reality content in a physical environment. FIG. 6A illustrates a presenter 600 sharing a physical document 630 with an audience of two viewers 610. As described in relation to FIG. 3, steps 310 and 320, the presenter 600 and the viewers 610 are within a viewing space of the physical document 630 and are each demonstrating the interest in the document 630 via gaze indications 640. In the example of FIG. 6A, the application 133 counts the number of viewers as 3. Further none of the other viewers or audience 610 has a physical copy of the document 630. Because the presenter 600 is also a viewer of the document 630 during execution of the method 400, step 410 sets control of the non-physical representations to the viewers 610 and not the presenter 600.

FIG. 6B illustrates the environment of FIG. 6A after the display of the non-physical representations 650 of the document 630 to the viewers 610. The scene of FIG. 6B shows after the presenter 600 withdrew presentation of the physical copy 630. FIG. 6B demonstrates why it is advantageous to give control to the viewers 610 and not the presenter 600. In the example of FIG. 6B, after the representations 650 are displayed in front of the viewers 610, little reason is left for the presenter 600 to leave the physical document 630 in a sharing related orientation. It is likely the presenter 600 would return the document 630 into an orientation which maximises his view of the document. In such an instance, display of the representations 650 is advantageously not dependent on the presentation of the physical document 630 which would occur at step 530 if control was given to the presenter 600.

FIGS. 7A-D show a graphical illustration of another example scenario of displaying a document as mixed reality content in a physical environment. FIG. 7A illustrates a presenter 700 sharing a physical document 730 with two viewers 710 and 720 (as indicated by gaze direction 740). In the example of FIG. 7a the presenter 700 is not included within the viewing space of the document 730. Based on step 330 of FIG. 3 the application 133 generates a viewer count of 2, causing step 230 to determine that the presenter is sharing the document 730. As the presenter 700 is not included in the viewer count, at step 430 the application 133 gives control of non-physical copies of the document 730 to the presenter 700.

FIG. 7B illustrates the environment of FIG. 7A where two non-physical representations 750 and 760 are displayed as mixed reality content in front of the viewers 710 and 720 respectively. Following the display of the non-physical copies 750 and 760 (as per the step 260) and determining that the presenter 700 has control (as per step 270), the application 133 proceeds to manage each non-physical representation, as per step 280.

FIG. 7C illustrates the environment of FIG. 7B where the viewer 720 interacts with their virtual representations 760 by placing a hand over or on the display of the representation 760. The application 133 executes at step 510 within the step 280 to detect the interaction and determines at step 520 that the viewer 720 has interacted with their associated representation 760. Control of the non-physical representation 760 is given to the viewer 720 as per the step 550. The viewer 710 did not interact with their associated non-physical representations 750, meaning the presenter 700 continues to control display of the representation 750.

FIG. 7D illustrates the environment of FIG. 7C after the presenter 700 has withdrawn the physical document 730. At step 530 of the step 280 the application 133 determines the presenter 700 has stopped sharing the physical document 730. Upon detecting that the presenter has ceased sharing the document, the application 133 at step 540 terminates the display of the non-physical representation 750 associated with the viewer 710. Due to the viewer 720 interacting with their associated representation 760, control relating to display of the representation 760 is assigned to viewer 720, thus their associated representation 760 remains visible. The copies 750 and 760 are controlled in the manner described above as viewer 720 has demonstrated through their actions a higher level of engagement over the non-physical representation 760 whereas a level of engagement of the user 710 is lower. Accordingly, the decision to terminate the display of a non-physical representation is assigned to the choice of the engaged viewer (720). FIG. 7D illustrates the viewer 720 still interacting with the non-physical representation 760 as the presenter 700 stops sharing the physical document. After initially interacting with the non-physical representation 760 the viewer is able to stop interacting, while still retaining display control of the non-physical representation.

The viewer 720 may decide that they no longer need to view the representation 760, and may indicate this by performing a predefined gesture detectable by the application 133.

In another implementation, the application 133 generates a non-physical copy by detecting a gesture which orientates a physical document in front of a person.

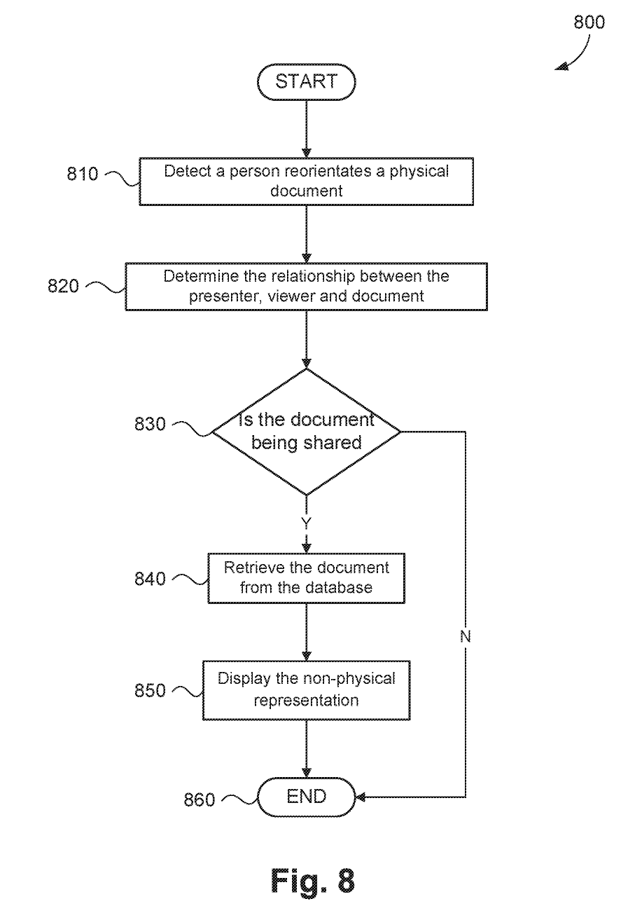

FIG. 8 shows a schematic flow diagram describing an alternate computer-implementable method 800 for displaying a non-physical copy of a document. The method 800 is typically implemented as one or more modules of the application 133, controlled by execution of the processor 105, and stored in the memory 106.

The method 800 begins at step 810. In execution of step 810 the application 133 detects a person reorienting a physical document within an environment. The step 810 operates in a similar manner to step 210 of FIG. 2. The method 800 continues to a step 820. The application 133 determines relationships in the physical environment between the presenter of the document, the viewer and the physical document at step 820. The application 133 makes the determination at the step 820 by first processing input frames from the camera 127 via the document tracking module 191 and the person tracking module 192. The document sharing module 193 determines the relationship relationships between the presenter, viewer(s) and the physical document. Operation of the step 820 is similar to operation of step 220 of FIG. 2 and is based upon an image of the environment.

The method 800 continues to a step 830. At step 830, the application 133 checks if the physical document is being shared. If the physical document is being presented or shown to the viewer (“Y” at step 830), the method 800 proceeds to a step 840. If the document is not being shared (“N” at step 830) the method 800 ends at an end step 860.

At step 840, the application 133 retrieves the corresponding electronic document from a database (similarly to the step 250). The method 800 continues to a step 850 and displays a non-physical representation of the document as mixed reality content to the viewer (similarly to the step 260). After the step 850 the method ends at step 860. Steps 840 and 850 operate similarly to steps 250 and 260 respectively.

The method 800 differs from the method 200 in that FIG. 2 relates to a presenter and a single viewer only. Accordingly, some steps, such as steps corresponding to the steps 270 and 280, are excluded from the method 800. However, if more than one viewer is present in the environment, the method 800 may be extended to operate in a similar manner to the method 200.

In addition to what is described above in relation to FIGS. 2-7 the application 133 may also be configured to graphically alter each non-physical representation instead of terminating display of the non-physical representation after the display duration has ended. For example, at step 540 the application could change transparency of the non-physical copy of the document to make appearance of the non-physical representation less perceptible while still being accessible to the viewer. In some implementations, display characteristics of the representations other than, or in addition too, display characteristics relating to transparency are modified instead of removing display of the document.

The advantage of such an implementation lies in still providing access to information provided in the document to the viewer. An instance may occur where the viewer was initially interested in the document shared by the presenter, thus triggering the display of a non-physical representation associated with the viewer. The viewer can then direct focus to another document. While the focus of the viewer is shifted from the non-physical representation the presenter may withdraw the physical document causing the non-physical representation to disappear as no interaction was made by the viewer. In such implementations the viewer could still see the document at a lower transparency and then access the previously shared representation.

In another implementation, in addition to what is described above in relation to FIGS. 1-7, the application 133 defines the viewing space of the physical document in binary terms by detecting viewers to be either in front or behind the physical document. At step 310, a viewing space of a physical document could be defined using a 2 dimensional (2D) virtual plane coinciding with the physical document plane where one side of the plane represents the front of the physical document and other side representing the backside of the document. The virtual plane would bisect the environment into two 3 dimensional (3D) volumes, one volume where people may be in front of the physical document and another volume with people behind the document. The people detected to be in the volume in front of the document are determined as viewers.

In further implementations, in addition to what is described above in relation to FIGS. 1-7, the application 133 introduces a temporal component to how viewers are determined. In such implementations, step 310 has a predetermined amount of time allocated for the presenter to effectively present the physical document to all intended viewers. The allocated time allows the presenter to rotate the document to show the physical document to all people. As the document is rotated and shown to all, the application 133, within the predetermined time frame, records the people who enter into the viewing space of the physical document. Any people who enter into the viewing space within the allocated time are determined to be viewers of the physical document.

The arrangements described are applicable to the computer and data processing industries and particularly for the mixed reality industries.

The arrangements described provide an effect of interpreting gestures made by people presenting a physical document in an environment, and acting on the detected gestures so that a document may be shared appropriately with a number of people without requiring direct instruction from the presenter. As sharing of the document is based upon the gesture of the presenter sharing the document, the sharing is based upon requirements of the user. When the sharing is based upon interaction of a viewer, e.g., by detecting a first interaction at step 320, or detecting engagement at step 520, sharing of the document also relates to an intention indicated by the viewer. Neither the presenter nor the viewers are required to manually set or request sharing of or access to information in the document.

The foregoing describes only some embodiments of the present invention, and modifications and/or changes can be made thereto without departing from the scope and spirit of the invention, the embodiments being illustrative and not restrictive.

1. A computer-implementable method of displaying a document as mixed reality content, the method comprising:
determining, via an image of a physical environment, a relationship between an orientation of a physical document, a presenter of the physical document, and a viewer of the physical document in the physical environment;
retrieving a virtual representation of the physical document when the determined relationship indicates that the physical document is presented to the viewer; and
displaying the retrieved virtual representation of the document to the viewer as mixed reality content in the physical environment.

2. The method according to claim 1 further comprising:
determining that the presenter is viewing the physical document from the determined relationship; and
providing the viewer of the document with control of display of the virtual representation of the document.

3. The method according to claim 1 further comprising:
determining that the presenter is not viewing the physical document according to the determined relationship; and
providing the presenter of the document with control of display of the virtual representation of the document.

4. The method according to claim 1, further comprising:
detecting, via the image, a number of people in the environment,
determining a count of how many of the people are viewing the physical document; and
displaying the retrieved virtual representation to each of the people viewing the physical document, each displayed representation associated with a display duration determined according to the count of how many people are viewing the physical document.

5. The method according to claim 1, further comprising:
detecting, via the image, a number of people in the environment,
determining a count of how many of the people are viewing the physical document; and
displaying the retrieved virtual representation to each of the people viewing the physical document, each displayed representation associated with a display duration determined according to the count of how many people are viewing the physical document, wherein
the display duration is determined according to a duration of the presentation of the physical document.

6. The method according to claim 1 wherein the viewer of the virtual document is provided control of the display of the virtual representation of the document if the viewer interacts with the virtual document.

7. The method according to claim 1 further comprising:
detecting, via the image, a number of people in the environment,
determining a count of how many of the people are viewing the physical document in the environment;
determining which of the people viewing the physical document lack a physical copy of the document; and
displaying the retrieved virtual representation as mixed reality content to each of the people determined to lack a physical document.

8. The method according to claim 1, further comprising
detecting a number of people in the environment, and
determining whether the people are within a viewing space associated with the physical document, wherein the representation of the retrieved virtual copy is displayed to each person determine to be within the viewing space.

9. The method according to claim 1, further comprising
determining, via the image, a viewing space of the physical document, and
determining, via one or more subsequent images, viewers of the document based upon detecting entry of one or more people into the viewing space within a predetermined time.

10. The method according to claim 1, wherein determining the relationship between the orientation of a physical document, the presenter of the physical document, and the viewer of the physical document in the physical environment comprises:
detecting that the presenter is presenting the document; and
detecting an interaction of the viewer in relation to the physical document.

11. The method according to claim 1, wherein the virtual representation of the document is displayed as mixed reality content by projection of the virtual representation in the physical environment.

12. A computer-implementable method of displaying a document as mixed reality content, the method comprising:
detecting, via an image of a physical environment, that a physical document is presented to an audience in the physical environment;
determining, via the image, a count of how many people are in the audience;
retrieving a virtual representation of the physical document when the physical document is presented to the audience in the physical environment; and
displaying, as mixed reality content in the physical environment, the retrieved virtual representation to each of the audience, each displayed representation having a display duration determined according to the count of people in the audience and a duration of the presentation of the physical document.

13. The method according to claim 12, wherein the display duration is determined according to whether a person presenting the physical document to the audience is viewing the physical document.

14. The method according to claim 12, wherein display of each virtual representation of the document is terminated after the display duration has ended.

15. The method according to claim 12, wherein one or more display characteristics of each virtual representation of the document is modified after the display duration has ended.

16. A mixed reality system, configured to:
capture an image of a physical environment;
determine, via the image, a relationship between an orientation of a physical document, a presenter of the physical document, and a viewer of the physical document in the physical environment;
retrieve a virtual representation of the physical document when the determined relationship indicates that the physical document is presented to the viewer; and
display the retrieved virtual representation of the document to the viewer as mixed reality content in the physical environment.

17. An apparatus, comprising:
a processor,
an image capture device for capturing an image of a physical environment;
and a memory, the memory having instructions thereon executable by the processor to:
determine, via the image of a physical environment, a relationship between an orientation of a physical document, a presenter of the physical document, and a viewer of the physical document in the physical environment:
retrieve a virtual representation of the physical document when the determined relationship indicates that the physical document is presented to the viewer; and
display the retrieved virtual representation of the document to the viewer as mixed reality content in the physical environment.

18. A non-transitory computer readable storage medium having a computer program stored thereon for modifying display of augmented reality content, comprising:
code for detecting, via an image of a physical environment, that a physical document is presented to an audience in the physical environment;
code for determining, via the image, a count of how many people are in the audience;
code for retrieving a virtual representation of the physical document when the physical document is presented to the audience in the physical environment; and
code for displaying, as mixed reality content in the physical environment, the retrieved virtual representation to each of the audience, each displayed representation having a display duration determined according to the count of people in the audience and a duration of the presentation of the physical document.
